(19) United States
(12) Patent Application Publication
(10) Pub. No.: US 2007/0224898 A1
(43) Pub. Date: Sep. 27, 2007

(54) Electrically conductive water repellant fabric composite

(76) Inventors: Alfred R. Deangelis, Spartanburg, SC (US); Jane E. Armstrong, Manchester (GB)

Correspondence Address: Legal Department (M-495), P.O. Box 1926, Spartanburg, SC, 29304, US

(21) Appl. No.: 11/390,037

(22) Filed: Mar. 27, 2006

(51) Int. Cl. B32B 27/04

(52) U.S. Cl. 442/79

(57) ABSTRACT

The invention relates to a water repellent, electrically conductive composite comprising an electrically conductive fabric comprising a first upper surface and a second lower surface, wherein the first upper surface opposes the second lower surface, a hydrophobic coating overlaying at least the first upper surface and second lower surface of the conductive fabric thereby forming a hydrophobic coated fabric, and barrier layers on the hydrophobic coated fabric such that the barrier layers form the outer surfaces of the water repellent, electrically conductive composite, and wherein the barrier layers are electrically insulating and water and water-vapor impermeable.

### FIELD OF THE INVENTION

The present invention refers to an electric heating element, more particularly a heating element to be used, e.g., for heating garments such as gloves.

### BACKGROUND

Electrically heated garments are well known. They may be formed of a flat envelope of a synthetic textile material containing an electric resistance wire which is mostly inserted in a zigzag or meandering shape but which may also have the form of a thin, flat ribbon. Often, in order to preserve performance attributes of the textile, the heated garment is made of a textile containing metal yarns, metallized yarns, or metallized fabric.

For many applications, it is desirable to protect the heated garment from moisture to prevent short circuits and/or material corrosion. A typical method used to treat electrically conductive fabric to make it water repellent is to coat it with a fluorochemical. Doing this reduces the extent to which the fabric will wet out, but does not make it waterproof.

Another way to protect the electrically conductive fabric from moisture is to laminate insulating layers around the fabric. However, if the insulating layers were to be cut or breached, or if they don't completely seal the edges of the article (for example, if the article is cut from a previously laminated fabric) liquid would wick into the conductive fabric, corroding the conductive fabric and reducing its functionality and/or creating shorts in the heating circuit.

There is a need for heated garments and the like to have a heated garment that may be submersible in water (waterproof) and that has added protection from short circuits and corrosion or chemical reaction with solutions in which the product is immersed.

### BRIEF DESCRIPTION OF THE DRAWINGS

An embodiment of the present invention will now be described by way of example, with reference to the accompanying drawings.

FIG. 1 is a cross-sectional view of one embodiment of the electrically conductive water repellant fabric composite.

FIG. 2 is a cross-sectional view of another embodiment of the electrically conductive water repellant fabric composite wherein the water repellant layer is directly on the conductive fabric.

FIG. 3 is a cross-sectional view of another embodiment of the electrically conductive water repellant fabric composite wherein the water repellant layer is directly on the hydrophobically treated conductive fabric.

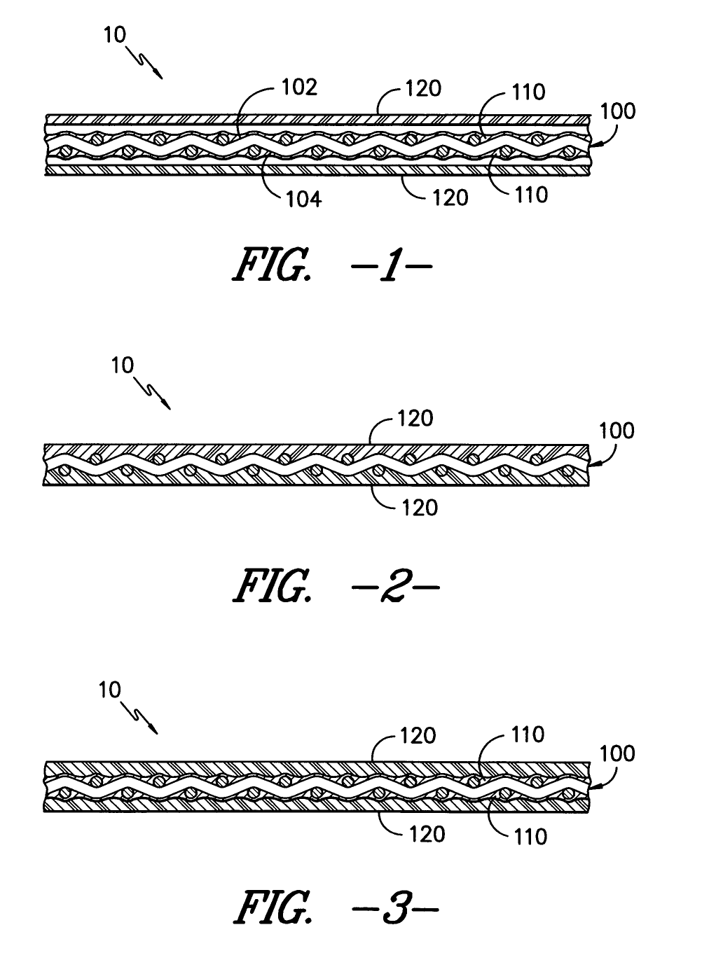

### DETAILED DESCRIPTION

Referring now to the drawing, there is shown a electrically conductive water repellent composite 10 including an electrically conductive fabric 100 having a first upper surface 102 and a second lower surface 104. The first upper surface 102 is opposed to the second lower surface 104. The conductive fabric 100 has a hydrophobic coating 110 overlaying at least the first upper surface 102 and second lower surface 104 of the conductive fabric 100. On the hydrophobic coating there are barrier layers 120 such that the barrier layers 120 form the outer surfaces of the electrically conductive water repellant composite 10. When not otherwise qualified in this specification, the words “conductive” and its forms refers to an article's electrical properties.

In order to be able submerge the conductive fabric 100 and the garments made from the conductive fabric in water, the conductive fabric 100 is sandwiched between two barrier layers 120 impermeable to both water and water vapor. If the barrier layers 120 were to be cut or breached and the conductive fabric 100 did not have a hydrophobic coating 110, the fabric would be exposed to the liquid environment, corroding the conductive fabric 100 and reducing its functionality. By coating the conductive fabric 100 with a hydrophobic coating 110 (which lies between the fabric and the barrier layers 120), it has been proven that the amount of corrosion seen by the conductive fabric 100, should the barrier layer be broken, is reduced. The hydrophobic materials reduce the extent to which the fabric wets out or wicks, so that if the barrier layers 120 are broken, liquid does not wick into the conductive fabric 100. Hence, corrosion is limited to a small area adjacent to the opening through the barrier layer 120. Additionally, the presence of the hydrophobic coating 110 on the conductive fabric 100 reduces the amount of current leakage to the water through the barrier layer 120.

The electrically conductive fabric 100 may be of any stitch construction suitable to the end use, including but not limited to a woven, knitted, non-woven material, tufted materials, or the like. Woven textiles can include satin, poplin, and crepe weave textiles. Knit textiles can include, but are not limited to, circular knit, warp knit, and warp knit with a microdenier face. The textile may be flat or may exhibit a pile. The conductivity of the electrically conductive fabric 100 will vary according to the end use. In one embodiment where the electrically conducive water repellent composite 10 is used as a heating garment, such as a glove, the resistivity of the electrically conductive fabric 100 is approximately 0.01 to 1 ohms.

In one embodiment, the conductive fabric 100 is composed fully or partially of conductive fibers or yarns. The electrically conductive yarns will typically have a resistivity of between 1 and 100 ohms per inch. The conductive fabric may also include nonconductive fibers or yarns including but not limited to man-made fibers such as polyethylene, polypropylene, polyesters (polyethylene terephthalate, polybutylene terephthalate, polytrimethylene terephthalate, polylactic acid, and the like, including copolymers thereof); nylons (including nylon 6 and nylon 6,6); regenerated cellulosics (such as rayon or Tencel); elastomeric materials such as Lycra; and high-performance fibers such as the polyaramids, polyimides, PEI, PBO, PBI, PEEK, liquid-crystalline, thermosetting polymers such as melamine-formaldehyde (Basofil) or phenol-formaldehyde (Kynol) and the like. The nonconductive materials may also include natural fibers such as cotton; coir; bast fibers such as linen, ramie, and hemp; proteinaceous materials such as silk, wool, and other animal hairs such as angora, alpaca, or vicuna. Blends of man-made fibers, natural fibers, or both types of fibers are anticipated. Man-made, non-cellulosic, fibers, such as basalt, glass, and ceramic are preferred for their lower moisture regain.

In one embodiment, the conductive fabric 100 comprises electrically conductive plated yarns. Preferably, the yarns are plated with silver, aluminum, copper, or nickel. These metals have been shown to have relatively high conductivity and tend to form protective oxide coatings upon corrosion. Preferably, the yarns have a resistivity of between 1 and 100 ohms per inch.

In another embodiment, the conductive fabric 100 comprises yarns whose fibers are coated with electrically conductive polymers. Preferably, the electrically conductive polymer of the invention is selected from the group consisting of substituted or unsubstituted aniline containing polymers, substituted or unsubstituted pyrrole containing polymers, and substituted or unsubstituted thiophene containing polymers. The above polymers provide the desired conductivity and adhesion to yarns.

In another embodiment, the conductive fabric 100 comprises wires or wire-wrapped yarns woven or knitted into the fabric. The electrically conductive wires may be wrapped around a nonconductive core yarn or around a conductive core.

In yet another embodiment, the conductive fabric 100 comprises a nonconductive fabric which is treated to be conductive. This may include, for example, a nonconductive fabric being coated with a conductive material or a nonconductive fabric with a plated layer of metal. Preferably, the fabric is plated with silver, aluminum, copper, or nickel. These metals have been shown to have relatively high conductivity and tend to form protective oxide coatings upon corrosion. Preferably, the fabric has a resistivity of between 0.01 and 1 ohms.

The electrically conductive fabric 100 has a hydrophobic coating 110 on at least the first upper surface 102 and the second lower surface 104 of the electrically conductive fabric 100. The hydrophobic coating 110 may surround the individual fibers or yarns of the conductive fabric 100 and may also be coated onto the cut sides of the conductive fabric 100. If the barrier layer 120 is breached or cut, the conductive fabric 100 is exposed to the liquid environment. If not treated with the hydrophobic coating 110, wicking and corrosion occurs throughout the conductive fabric 100. The purpose of the hydrophobic coating 110 is to inhibit or lessen the wettability of the conductive fabric 100, so that if the barrier layer 120 is broken, liquid does not wick into the conductive fabric 100. Hence, corrosion is limited to a small area adjacent to the cut in the barrier layer 120. Also, electrical shorting due to conduction through the liquid is reduced.

The hydrophobic coating may contain fluorochemicals, perfluorinated polymers and surfactants, homo- or copolymers with at least one polymer segment containing perfluorinated side-groups, silicone polymers with alkyl- or aryl-side groups, resin-based finishes, waxes, wax-metal emulsions, organometallic complexes, and combinations thereof. Preferably, the hydrophobic coating comprises a fluorochemical. Fluorochemical repellants include chemicals that contain perfluorocarbon groups. The fluorochemical repellants can be the products of copolymers of perfluoroalkyl acrylates or methacrylates with other comonomers. The comonomers include esters of acrylic or methacrylic acid containing alkyl groups, alkylamide groups, or polyether groups. The hydrophobic coating reduces or prevents wicking of water into the fabric. The coating is such that incident water droplets fail to substantially wet the surface of the fabric.

On the hydrophobic coating there are barrier layers 120 such that the barrier layers 120 form the outer surfaces of the electrically conductive water repellant composite 10. The barrier layers 120 serve to isolate the conductive fabric 100 from the environment or water. The barrier layers 120 are electrically insulating and water and water-vapor impermeable. Water-vapor impermeable is defined to be a MVTR (moisture vapor transfer rate) through the barrier layer of less than 300 g/m²/day, more preferably 100 g/m²/day, as determined using ASTM E-96 procedure B. Water impermeable means capable of sustaining a hydrostatic pressure of ≧100 mbar across the barrier layer as measured by test method AATCC™ 127. The electrical resistivity of the electrically insulating barrier layer is at least 10¹² ohms. Preferably, the barrier layer is made of polyvinyl chloride, polyurethane, silicone, neoprene, or other known barrier layers with the desired physical characteristics. For certain applications, it may be desirable for the layer to have good stretch, elasticity, or flexibility, so as not to noticeably change the performance of the fabric. The barrier layer preferably has a melting point/softening point above the temperature of the heating element output. In one embodiment, the melting point/softening point is preferably above 250° F.

The electrically conductive water repellant fabric composite's power source is one capable of supplying sufficient electrical current and may be a battery or may be a connection to a “wired” power source (an electrical cord to a wall outlet, for example). Although the technologies are fledgling, alternative power sources capable of producing electrical current also include photovoltaic panels and fuel-cells.

Connection to external power sources, which at this point in time is the most common incidence, requires an electrical connection to be made through the barrier layer. This may be accomplished by passing wires or electrical connectors through the barrier layer. The wires or connectors may be either insulated or uninsulated. They connect with the power source or a controller exterior to the barrier. After passing wires through the barrier layer, a suitable water-impervious material may be used to seal the entry point from moisture. Suitable water-impervious materials include, but are not limited to, silicone, acrylic, or urethane caulks; epoxy resins; hot-melt (thermoplastic) resins; reactive thermoset resins; solvent-borne polymers, and the like.

The electrically conductive water repellant composite 10 is formed by coating the hydrophobic coating on the electrically conductive fabric 100 on at least the first upper side 102 and the second lower side 104. The hydrophobic coating may be applied using a known coating technique, including but not limited to such as dip coating, knife coating, extrusion coating, spin coating, screen printing, slide hopper coating, padding on, and curtain coating. In one embodiment, the hydrophobic coating is applied by padding on a hydrophobic solution. Next, the hydrophobic coating may be cured at an elevated temperature, usually between 200 and 400° F. (93.3-204.4° C.). In the case of fluoropolymers, the cure step helps to orient the perfluorinated groups, maximizing the repellency, and may also serve to react the materials to themselves or to the substrate.

Next, the barrier layers 120 are applied to the hydrophobic coating 110 such that the barrier layers 120 form the outermost surfaces of the electrically conductive water repellent composite 10. Either or both physical and chemical means of adhesion are possible. The barrier layers 120 may be laminated or adhered to the hydrophobic coating 110 with an adhesive. Additionally, the barrier layers 120 may be attached to the hydrophobic coating 110 at the seams in the resultant heated garment or at intervals on the hydrophobic coating 110. The barrier layers 120 may be softened so as to self-adhere to the hydrophobic coating 110, though this may result in pinholes in the barrier layer 120 and is not preferred. The barrier layers 120 serve as a water barrier, so that it becomes possible to submerse the composite 10 in water without wetting the underlying fabric 100.

The composite may be formed into articles of apparel, such as jackets, sweaters, hats, gloves, shirts, pants, socks, boots, and shoes, and into home furnishing textile articles, such as blankets, throws, and seat warmers. In one embodiment, a conductive textile is treated with water repellent chemistry and then is laminated with a barrier material on a first surface. This conductive textile with a barrier material applied to a first surface is then cut into hand-shaped pieces, suitable for incorporation into a glove. These pieces are then adhered to a support textile, barrier side to textile, and formed into a glove. Conductive paste or yarn is used to connect the finger tips and thus form a complete electrical circuit. A second barrier material is then applied to the second, outer, surface of the conductive textile such that the conductive textile is encapsulated between the two barrier layers. Optionally, a water-impermeable sealant is applied to any sections where the barrier layers may have been punctured during glove fabrication.

Flexibility is highly desirable for many textile applications, especially under the conditions for which the object or garment is devised—for example, good cold-flex is important for heating articles to be used at temperatures below 400F. It is also important, as is discussed elsewhere, for the laminate to maintain integrity upon activation of the conductive textile (heating).

### EXAMPLES

### Preparation of Examples

The prepared examples using insulated conductive fabric s/3035-213 Ni/Cu plated polyester taffeta from Laird Technologies of St. Lous, Mo. were treated with the following coatings. All percentages are by weight unless otherwise specified.

### Example 1

### No Chemical Treatment Coating (Control)

### Example 2

### 2% BK 96 Fluorocarbon Water Repellent in 98% Water

### Example 3.

### 2% Nicca 640 Fluorocarbon Water Repellent in 98% Water

Example fabrics 2 and 3 were dipped in the chemical coatings, padded at 60 psi and a speed of 30 yards per minute, and then cured in an oven at 350° F. for 5 minutes.

For each of the examples, two pieces of conductive silver-coated nylon filament yarn from Sauquoit Industries of Scranton, Pa. were sewn along opposite edges of each example to act as electrical leads. Each example was then laminated between two pieces of Santoprene 8291-85 polyurethane thermoplastic film (available from Advanced Elastomer Systems, an affiliate of ExxonMobil Chemical Company) using heat and pressure. Lamination was done by placing the fabric between the two sheets of film such that the film covered the entire fabric but the leads extended out of the film.

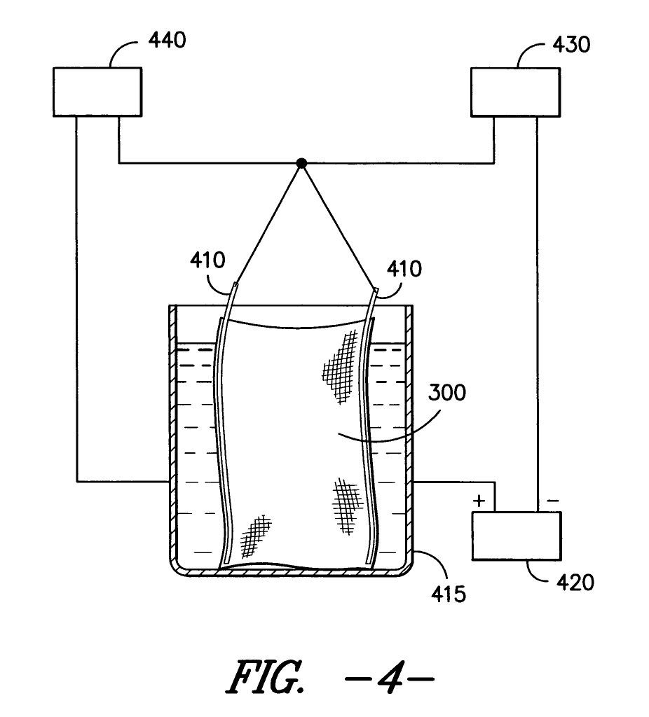

The resulting structure of Example 1 is shown in FIG. 2. The conductive fabric 100 is surrounded by the polyurethane layers 120, where the polyurethane layers form the outer most surface of the fabric composite 10. The resulting structures of Examples 2 and 3 are shown in FIG. 3. In FIG. 3, the conductive fabric 100 coated with the fluorocarbon chemistry 110 and is surrounded by the polyurethane layers 120, where the polyurethane layers form the outer most surface of the fabric composite 10.

### Initial Electrical Conductivity Testing (Resistance)

The Examples were first tested for electrical continuity from one lead to the other by hooking each lead to a Radio Shack 22-183A digital multimeter set to measure resistance. The measured resistance due to the probes of the multimeter was 0.6 ohms. The measured resistance of each fabric, after subtracting out the resistance due to the probes, is shown in Table 1. The resistances indicate that each fabric example was electrically continuous.

TABLE 1
Initial resistances of the fabric composite examples

| | Initial Resistance |
|---|---|
| Example 1 | 4.7 ohms |
| Example 2 | 3.3 ohms |
| Example 3 | 5.2 ohm |

### Water Durability Testing

The Examples were tested for their electrical water durability in a system shown in FIG. 4. The fabric composite examples 300 were immersed one at a time into metal container 415 containing 1700 ml of water into which 170 mg of NaCl had been dissolved. The fabric composites 300 were not completely immersed, so that the exposed portion of leads 410 were not in the salt water. The fabric composites 300 and container 415 were used to create an electrical circuit, as described below.

The positive terminal of power supply 420, model HP6267B from Hewlett Packard, was connected directly to the metal container 415. The negative terminal of the power supply 420 was connected to one probe of first multimeter 430 (22-183A multimeter from Radio Shack) set to measure current. The other probe of first multimeter 430 was connected to both leads 410 of fabric composite 300 immersed in salt water in container 415. At the same time, the one probe of second multimeter 440 (ECG DM-37 from Omega) was connected to metal container 415 and the other to exposed leads 410, and second multimeter 440 was set to monitor the voltage between those two points.

A DC voltage was applied between container 415 and fabric composite 300 using the power supply 420. The applied voltage was monitored using second multimeter 440, and the current through the circuit was recorded using first multimeter 430.

In this system, the salt water is a part of the electrical circuit. Therefore, if the insulating layers of fabric composite 300 prevented any moisture from contacting the fabric, no current would pass through the circuit. Table 1 shows the measured current in microamps as a function of the applied voltage. First multimeter 430 is capable of measuring currents down to 1 microamp, and the limit of the power supply 420 is 40 volts. To check the test setup, fabric leads 410 were briefly shorted to metal container 415 at 0.2 volts. The meter measured 130 microamps, validating the circuit.

TABLE 2
Initial water durability of the conductive fabric composite examples

| | Applied voltage, initial soak | | | | |
|---|---|---|---|---|---|
| | 6 volts | 12 volts | 15 volts | 25 volts | 40 volts |
| Example 1 | 0 | 1 | 1 | 1–2 | 2 |
| Example 2 | 0 | 0 | 0 | 0 | 0 |
| Example 3 | 0 | 0 | 0 | 0 | 0 |

Next, all 3 examples were left to soak in salt water overnight. Measurements were taken again for each example, as described above, one at a time. The measured currents are found in Table 3.

TABLE 3
Overnight water durability of the conductive fabric composite examples

| | Applied voltage, overnight soak | | | | |
|---|---|---|---|---|---|
| Sample | 6 volts | 12 volts | 15 volts | 25 volts | 40 volts |
| Example 1 | 0 | 1 | 1 | 2 | 3 |
| Example 2 | 0 | 0 | 0 | 0 | 0 |
| Example 3 | 0 | 0 | 0 | 0 | 0 |

Table 3 shows that example fabric composites 300 each kept their electrical integrity even after long exposures to salt water. The moderately increased current in the first example (with no hydrophobic coating on the fabric) suggests there may have been some wicking at the edges of the example.

Immediately after the above test, a small incision about 2″ long was made in the approximate center of each example. The examples were again immersed in the salt water. The measured currents from each example with an incision when immersed in the salt water are found in Table 4.

TABLE 4
Water durability of the conductive fabric composite
examples initially when slit

Applied voltage,
incision, initial soak

| Sample | 6 volts | 12 volts | 25 volts | 40 volts |
|---|---|---|---|---|
| Example 1 | 2 | 2 | 3 | 4 |
| Example 2 | 2 | 2 | 3 | 2 |
| Example 3 | 2 | 2 | 2 | 2 |

The cut examples were left to soak in the salt water for 8 days. Visually, there were clear differences between the first example (control) and the second and third examples treated with a water repellent chemistry. The first example had a large area of discoloration several inches around the incision. Salt crystals had formed on leads, presumably from salt-water wicking through the fabric and up the leads. The second and third examples showed none of these features, but only a small area of discoloration for approximately 2-3 mm around the incision. The examples were retested for current leakage, and the results are shown the Table 5.

TABLE 5
Water durability of slit conductive fabric
composite examples after 8 days

Applied voltage,
incision, 8-day soak

| Sample | 6 volts | 12 volts | 25 volts | 40 volts |
|---|---|---|---|---|
| Example 1 | 7 | 8 | 8 | 8 |
| Example 2 | 2 | 3 | 3 | 2 |
| Example 3 | 3 | 5 | 6 | 3 |

### Electrical Conductivity Testing (Resistance) After Water Durability Testing

After the water durability tests (including slitting and soaking in slat water), the examples were removed from the salt water and allowed to air-dry for 3 days. The examples were then retested for electrical continuity from one lead to another using a Fluke 85III multimeter set to measure resistance. The measured resistance due to the probes was 1.1 ohms. The measured resistances of each fabric example, after subtracting out the resistance due to the probes are found in the second column of Table 5. The third column has the relative increases in the resistance of each example.

TABLE 6
Resistance of examples after water durability testing and change in
resistance compared to initial resistance

| | | Percentage Increase |
|---|---|---|
| | Resistance | Compared to Table 1 |
| Example 1 | 13.9 ohms | 200% |
| Example 2 | 4.0 ohms | 18% |
| Example 3 | 5.4 ohms | 3.4% |

The results show that the combination of the water repellent chemistry coated onto the fabric, along with the barrier layer is effective at limiting wicking into the fabric and limiting both the current leakage through edges and cuts as well as damage to the conductive fabric.

What is claimed is:

1) An electrically conductive water repellent composite comprising:
an electrically conductive fabric comprising a first upper surface and a second lower surface, wherein the first upper surface opposes the second lower surface;
a hydrophobic coating overlaying at least the first upper surface and second lower surface of the conductive fabric thereby forming a hydrophobic coated fabric; and,
barrier layers on the hydrophobic coated fabric such that the barrier layers form the outer surfaces of the electrically conductive water repellent composite, and wherein the barrier layers are electrically insulating and impermeable to water and water vapor.

2) The electrically conductive water repellent composite of claim 1, wherein hydrophobic coating comprises a fluorochemical.

3) The electrically conductive water repellent composite of claim 2, wherein hydrophobic coating comprises a fluorocarbon.

4) The electrically conductive water repellent composite of claim 1, wherein the electrically insulating material comprises a polymer selected from the group consisting of polyvinyl chloride, polyurethane, silicone, polychloroprene, thermoplastic polyolefins, acrylic homo- or copolymer latex, and styrene-butadiene rubber.

5) The electrically conductive water repellent composite of claim 1, wherein the conductive fabric comprises conductive yarns.

6) The electrically conductive water repellent composite of claim 1, wherein the conductive fabric comprises conductive yarns and nonconductive yarns.

7) The electrically conductive water repellent composite of claim 1, wherein the conductive fabric comprises electrically conductive plated yarns.

8) The electrically conductive water repellent composite of claim 1, wherein the conductive fabric comprises a plated layer of metal.

9) The electrically conductive water repellent composite of claim 8, wherein the metal comprises a material selected from the group consisting of silver, aluminum, copper, and nickel.

10) The electrically conductive water repellent composite of claim 1, wherein the conductive fabric comprises a coating of conductive material.

11) The electrically conductive water repellent composite of claim 10, wherein the conductive material is selected from the group consisting of carbon, intrinsically conducting polymers, silver, aluminum, copper, and nickel.

12) A process for forming an electrically conductive water repellent composite comprising in order:
applying a hydrophobic coating to an electrically conductive fabric on at least a first upper surface and a second lower surface thereby forming a hydrophobic coated fabric; and,
applying barrier layers to the hydrophobic coated fabric such that the barrier layers form the outer surfaces of the water repellent, electrically conductive composite, and wherein the barrier layers are electrically insulating and impermeable to water and water vapor.

13) The process of claim 12, wherein the wherein hydrophobic coating comprises a fluorochemical.

14) The process of claim 12, wherein the electrically insulating material comprises a polymer selected from the group consisting of polyvinyl chloride, polyurethane, silicone, and polychloroprene.

15) The process of claim 12, wherein the conductive fabric comprises conductive yarns.

16) The process of claim 12, wherein the conductive fabric comprises conductive yarns and nonconductive yarns.

17) The process of claim 12, wherein the conductive fabric comprises electrically conductive plated yarns.

18) The process of claim 12, wherein the conductive fabric comprises a plated layer of metal selected from the group consisting of silver, aluminum, copper, and nickel.

19) The process of claim 12, wherein the conductive fabric comprises a coating of conductive material.

20) The electrically conductive water repellent composite of claim 19, wherein the conductive material is selected from the group consisting of carbon, intrinsically conducting polymers, silver, aluminum, copper, and nickel.

21) The process of claim 12, wherein applying the hydrophobic coating comprises padding on an aqueous solution comprising a hydrophobic material.

22) The process of claim 12, wherein the barrier layers are applied to the hydrophobic coated fabric by a method selected from the group consisting of lamination, extrusion coating, dip coating, knife coating, spray coating and foam coating.

23. The process of claim 12, further comprising forming the electrically conductive water repellent composite into a heated article.

24. The process of claim 23, wherein a water-impermeable sealant is applied to any sections of the barrier layers may have been punctured during formation into a heated article.
